(19) United States
(12) Patent Application Publication
(10) Pub. No.: US 2006/0212191 A1
(43) Pub. Date: Sep. 21, 2006

(54) Rechargeable traveling system

(75) Inventor: Ryo Saeki, Osaka (JP)

Correspondence Address: Yokoi & Co., U.S.A., Inc., 13700 Marina Pointe Drive #723, Marina del Rey, CA, 90292, US

(73) Assignee: Funai Electric Co., Ltd., Osaka (JP)

(21) Appl. No.: 11/369,143

(22) Filed: Mar. 6, 2006

(30) Foreign Application Priority Data
Mar. 8, 2005 (JP) JP2005-063873
Mar. 24, 2005 (JP) JP2005-086321

(51) Int. Cl. A47L 5/00; G01C 22/00

(52) U.S. Cl. 701/23; 15/319; 701/25

(57) ABSTRACT

It is an object to provide a rechargeable traveling system that can smoothly carry out the automatic charging. Because the position of a sidewall sensor 36 is set to satisfy the equation a=(1/2)b, when a body BD is parallel to wall W, for distance (a) between the line extending perpendicular to the wall W from pivot point C and the sidewall sensor 36 and for width (b) of a feeding section 102 of a charging unit 100, subsequently when the body BD is rotated so that a charging terminal 27a placed in the rear center of the body BD and a feeding terminal 102a of the charging unit 100 face each other, the charging terminal 27a and the feeding terminal 102a face each other without any displacement.

### BACKGROUND OF THE INVENTION

1. Field of the Invention:

The present invention relates to a rechargeable traveling system, and particularly relates to a system comprising a self-propelled cleaner that is provided with a body including a cleaning mechanism and with a drive mechanism for realizing steering and driving, and a charging unit for charging the self-propelled cleaner.

2. Description of the Related Art:

Heretofore, there has been disclosed a technology that is involved in a rechargeable traveling system comprising a traveling unit including a drive mechanism for realizing steering and driving, and a charging unit for charging the relevant self-propelled unit, and that allows the traveling unit to automatically travel to the charging unit to carry out charging when the remaining volume of a battery in the traveling unit decreases (for example, see Japanese Patent Publication Laid-Open No. HEI 07-064637, Japanese Patent Publication Laid-Open No. HEI 07-325620, Japanese Patent Publication Laid-Open No. 2002-268746)

Further, as a technology that is involved in a rechargeable traveling system comprising a traveling unit including a drive mechanism for realizing steering and driving, and a charging unit for charging the relevant self-propelled unit, and that allows the traveling unit to automatically travel to the charging unit to carry out charging when the remaining volume of the battery in the traveling unit decreases, there have been disclosed, for example, Japanese Patent Publication Laid-Open No. 2004-275716, Japanese Patent Publication Laid-Open No. 2002-325707, Japanese Patent Publication Laid-Open No. 2002-318620, Japanese Patent Publication Laid-Open No. HEI 07-8428 and Japanese Patent Publication Laid-Open No. 2003-36116.

### SUMMARY OF THE INVENTION

The following has been proposed by the applicant as the automatic charging method described above. That is, the traveling unit first carries out the wall side travel that travels along a wall in a room, and when detecting an obstacle (the charging unit) mounted on the wall, rotates a body by 90 degrees to travel away from the wall, while measuring the depth of the obstacle. When the measured depth is identical to a previously stored depth of the charging unit, subsequently the traveling unit rotates again the body by 90 degrees and then travels to be parallel to the wall, while measuring the distance from an end of the obstacle to a convex portion formed on the obstacle. When the distance is identical to a previously stored distance to a feeding section formed protruding in the charging unit, the traveling unit determines the obstacle as the charging unit. In other words, it makes the determination of the charging unit by the coincidence of the two distances, the depth of the charging unit and the distance from the end of the charging unit to the feeding section thereof.

In the rechargeable traveling system employing the above described automatic charging method, a sidewall sensor made up of a photo reflector and the like is used for measuring the depth of the charging unit and the distance from the end of the charging unit to the feeding section. For example, in the case of measuring the distance from the end of the charging unit to the feeding section, the traveling unit measures the distance from when the end of the charging unit is detected by the sidewall sensor to when the protruded feeding section is detected by the sidewall sensor.

Then, when the obstacle is determined as the charging unit based on the measurement results of the above described two distances, the traveling unit carries out charging by causing the charging terminal provided in a central portion on the rear side of the body of the traveling unit to touch the feeding terminal on the battery charging side, in which when the traveling unit rotates the body in order to direct the charging terminal toward the charging unit side, the charging terminal and the feeding terminal must face each other without any displacement so that subsequently the traveling unit can cause the body to travel straight back to carry out charging.

However, in the above described rechargeable traveling system, it is required to adjust the relative positions of the charging terminal and the feeding terminal so that they are located opposite each other after the determination of the charging unit is made and the body is rotated, thereby the traveling unit has carried out a fine adjustment such as causing the body to travel forward or backward after the determination of the charging unit. Thus, there has been a problem of taking time to allow the traveling unit to carry out the automatic charging.

Meanwhile, in the above described rechargeable traveling system disclosed in JP-A-2004-275716, an infrared emission section is provided for guiding the self-propelled cleaner to the charging unit side and a problem of cost increase arises.

Further, in the rechargeable traveling system described in the other JP-A-2002-325707, JP-A-2002-318620, JP-A-07-8428, and JP-A-2003-36116, an error is likely to occur in the recognition of the charging unit, which has caused a problem that the automatic charging is easily failed.

The invention is made in light of the above problems, and an object is to provide a rechargeable traveling system that can smoothly carrying out the automatic charging.

Another object is to provide a rechargeable traveling system that ensures the automatic charging while suppressing the cost increase.

In order to achieve the above objects, the invention comprises a rechargeable traveling system comprising a traveling unit and a charging unit,

wherein the traveling unit includes: a drive mechanism for realizing steering and driving; front obstacle sensors for detecting a front obstacle; sidewall sensors for detecting a lateral obstacle; and a charging terminal for carrying out charging, placed in the rear center of the body, the traveling unit being capable of traveling straight, traveling backward, and rotating around a predetermined pivot point, and

the charging unit has a convex shape with a predetermined width, which is mounted on a wall in a room so as to protrude therefrom and provided with a feeding section in which a feeding terminal to be connected to the charging terminal of the traveling unit is placed,

the traveling unit further including an automatic charging control processor for allowing the traveling unit to connect the charging terminal to the feeding terminal of the charging unit, after carrying out the automatic travel and moving to the vicinity of the charging unit,

the automatic control processor including:

a first measurement section for measuring the depth of the obstacle by measuring the travel distance, when the traveling unit carries out the wall side travel that travels along the wall in the room, and in response to the detection of a front obstacle by the front obstacle sensors during the wall side travel, rotates the body by 90 degrees and then travels perpendicular to the wall, while the obstacle is being detected by the sidewall sensor;

a second measurement section for measuring the distance from an end of the obstacle to a convex portion thereof by measuring the travel distance, when the traveling unit rotates the body by 90 degrees and then travels parallel to the wall after completion of the measurement by the first measurement section, during the period from when the end of the obstacle is detected to when the convex portion formed on the obstacle is detected by the sidewall sensor; and

a charging unit search processor for determining whether or not the obstacle is the charging unit based on the measurement results by the first and second measurement sections,

wherein the position of the sidewall sensor is designed to be set to satisfy the equation (1), when the body is parallel to the wall, for distance (a) between the line extending perpendicular to the wall from the pivot point of the body and the position in which the sidewall sensor is placed, and for width (b) of the feeding section in the charging unit:
a=(½)b (1)

In the invention configured as described above, the rechargeable traveling system comprises a traveling unit and a charging unit, wherein the traveling unit includes: a drive mechanism for realizing steering and driving; front obstacle sensors for detecting a front obstacle; sidewall sensors for detecting a lateral obstacle; and a charging terminal for carrying out charging, placed in the rear center of the body, and the traveling unit can travel straight, travel backward and rotate around a predetermined pivot point. The charging unit has a convex shape with a predetermined width, which is mounted on a wall surface in a room so as to protrude therefrom and provided with a feeding section in which a feeding terminal to be connected to the charging terminal of the traveling unit is placed.

Further, the traveling unit includes an automatic charging control processor for allowing the traveling unit to carry out the automatic travel and to connect the charging terminal to the feeding terminal of the charging unit. In other words, when the remaining volume of the battery decreases or a predetermined instruction to start charging is present, the traveling unit carries out the homing control that the traveling unit traveling away from the charging unit automatically travels to the charging unit and connects the charging terminal on the traveling unit side to the feeding terminal on the charging unit side to carry out charging.

This automatic charging control processor includes: a first measurement section for measuring the depth of the obstacle by measuring the travel distance, when the traveling unit carries out the wall side travel that travels along the wall in the room, and in response to the detection of the front obstacle by the front obstacle sensors in the wall side travel, rotates the body by 90 degrees and then travels perpendicular to the wall, while the obstacle is being detected by the sidewall sensor; a second measurement section for measuring the distance from an end of the obstacle to a convex portion thereof by measuring the travel distance, when the traveling unit rotates the body by 90 degrees and then travels parallel to the wall after completion of the measurement by the first measurement section, during the period from when the end of the obstacle is detected to when the convex portion formed on the obstacle is detected by the sidewall sensor; and a charging unit search processor for determining whether or not the obstacle is the charging unit based the measurement results by the first and second measurement sections. In other words, it determines the obstacle as the charging unit when the two distances, the depth of the portion protruding from the wall in the obstacle detected ahead during the wall side travel and the distance from the end of the obstacle to the convex portion thereof, are identical to the previously stored distances of the charging unit.

Then, the position of the sidewall sensor is set to satisfy the above equation (1), when the body is parallel to the wall, for the distance (a) between the line extending perpendicular to the wall from the pivot point of the body and the position in which the sidewall sensor is placed, and for the width (b) of the feeding section in the charging unit as the setting position of the sidewall sensor in the traveling unit. Because of this feature, after the measurement by the second measurement section is completed and the body is stopped, when the traveling unit rotates the body by 90 degrees to direct the charging terminal of the traveling unit toward the charging unit side, the charging terminal and the feeding terminal face each other without any displacement, and then the traveling unit just moves back to allow the charging terminal and feeding terminal to be connected. This eliminates the need to carry out precise adjustment for adjusting the position of the traveling unit, making it possible to smoothly carry out the automatic charging.

In another aspect of the invention, the body of the traveling unit is configured to have a cylindrical shape.

With the configuration as described above, although the traveling unit travels toward the feeding terminal of the charging unit in the state of slightly displacing relative to the charging unit, it is possible to connect the charging terminal on the traveling unit side and the feeding terminal on the charging unit side without fail.

Further, in another aspect of the invention, the traveling unit is configured to include a rotary encoder for measuring the travel distance from the rotation number of the wheels.

With the configuration as described above, it is possible to measure the travel distance of the traveling unit from the rotation number of the wheels.

Further, in another aspect of the invention, the traveling unit is configured to be a self-propelled cleaner including a cleaning mechanism.

With the configuration as described above, there is no longer need for a user to carry the cleaner around for doing the cleaning, so that the burden on the user who does the cleaning can be reduced.

Further, in another aspect of the invention, the cleaning mechanism is configured to be stopped while the automatic charging is carried out by the automatic charging control processor.

With the configuration as described above, it is possible to suppress the power consumption while the automatic charging is carried out (for example, during the wall side travel).

Further, the invention is configured to comprise a rechargeable traveling system comprising:

a traveling unit including: a drive mechanism for realizing steering and driving; front obstacle sensors for detecting a front obstacle; sidewall sensors each made up of a photo reflector for detecting a lateral obstacle, a travel distance measurement section for measuring the travel distance; and a charging terminal, the traveling unit being capable of traveling straight, traveling backward, and rotating around a predetermine pivot point, and a charging unit mounted on a wall in a room so as to protrude therefrom, which is provided with a feeding section in which a feeding terminal to be connected to the charging terminal of the traveling unit is placed, in a substantially central portion of the front of the body section, wherein the body section and feeding section in the charging unit are configured to have the different reflectance of the infrared light emitted from the sidewall sensor respectively,

the traveling unit further including:

a first measurement section for measuring the width of the feeding section by measuring the travel distance by the travel distance measurement section, while the feeding section is being detected by the sidewall sensor, by taking advantage of the fact that the sensor output value is different between when the infrared light from the sidewall sensor is irradiated onto the body section and when it is irradiated onto the feeding section; and

a connection control processor for allowing the charging terminal of the traveling unit to be connected to the feeding terminal of the charging unit, by determining as the charging unit to carry out charging, when the width of the feeding section measured by the first measurement section is identical to the previously stored width of the feeding section.

In the invention configured as described above, the rechargeable traveling system comprises a traveling unit and a charging unit. The traveling unit includes: a drive mechanism for realizing steering and driving; front obstacle sensors for detecting a front obstacle; sidewall sensors for detecting a lateral obstacle; a travel distance measurement section for measuring the travel distance; and a charging terminal for carrying out charging, and can travel straight, travel backward, and rotate around a predetermined pivot point. The charging unit is mounted on a wall in a room so as to protrude therefrom and provided with a feeding section in which a feeding terminal to be connected to the charging terminal of the traveling unit is placed, in a substantially central portion of the front of the body section.

Further, the body section and feeding section in the charging unit are configured to have the different reflectance of the infrared light emitted from the sidewall sensor respectively. Such a configuration may include, for example, a configuration in which the body section is colored in black and the feeding section is colored in white so that the infrared reflectance in the feeding section is higher than in the body section. In this case, the sensor output value of the sidewall sensor is higher when the infrared light is irradiated onto the feeding section.

Further, the traveling unit includes: a first measurement section for measuring the width of the feeding section by measuring the travel distance by the travel distance measurement section, while the feeding section is being detected by the sidewall sensor, by taking advantage of the fact that the sensor output value is different between when the infrared light from the sidewall sensor is irradiated onto the body section and when it is irradiated onto the feeding section; and a connection control processor for allowing the charging terminal of the traveling unit to be connected to the feeding terminal of the charging unit by determining as the charging unit to carry out charging, when the width of the feeding section measured by the first measurement section and the previously stored width of the feeding section are identical. In other words, the sensor output value is different between when the body section is detected and when the feeding section is detected by the sidewall sensor during the travel of the traveling unit, and by taking advantage of this fact, it is possible to measure the width of the feeding section by measuring the travel distance, while the feeding section is being detected by the sidewall sensor during the travel of the traveling unit. When the previously stored width of the feeding section and the measurement result by the first measurement section are identical, the traveling unit determines that the feeding unit is the charging unit to carry out charging, and thereby carries out the charging operation. With this configuration, there is no need to provide specific equipment on the charging unit side, allowing the traveling unit to find the charging unit and carry out the automatic charging without fail.

As a more specific configuration, the invention may also have the following configuration.

A rechargeable traveling system comprising:

a self-propelled cleaner including: a drive mechanism for realizing steering and driving; a cleaning mechanism; front obstacle sensors for detecting a front obstacle; sidewall sensors each made up of a photo reflector for detecting a lateral obstacle; a travel distance measurement section for measuring the travel distance; and a charging terminal for carrying out charging, a self-propelled cleaner being capable of traveling straight, traveling backward and rotating around a predetermined pivot point, and

a charging unit mounted on a wall surface in a room so as to protrude therefrom and provided with a feeding section in which a feeding terminal to be connected to the charging terminal of the traveling unit is placed, in a substantially central portion of the front of the body section,

wherein the body section and feeding section in the charging unit are configured to have the different reflectance of the infrared light emitted from the sidewall sensor respectively,

the self-propelled cleaner including, as the sidewall sensors, front sidewall sensors provided in left and right on the front side of the body and rear sidewall sensors provided in left and right on the rear side of the body,

the self-propelled cleaner further including:

a second measurement section for measuring the depth of the charging unit by measuring the travel distance in the travel distance measurement section, when the self-propelled cleaner carries out the wall side travel that travels along the wall in the room, and in response to the detection of the charging unit ahead by the front obstacle sensors during the wall side travel, rotates the body by 90 degrees and then travels perpendicular to the wall in order to carry out charging, while the charging unit is being detected using the rear sidewall sensor;

a first measurement section for measuring the width of the feeding section by measuring the travel distance in the travel distance measurement section, while the feeding section is being detected by the sidewall sensor, by taking advantage of the fact that the sensor output value is different between when the infrared light from the sidewall sensor is irradiated onto the body section and when it is irradiated onto the feeding section,

the first measurement section being configured to carry out the measurement after the second measurement section carried out the measurement; and

a connection control processor for allowing the charging terminal of the traveling unit to be connected to the feeding terminal of the charging unit, by determining as the charging unit to carry out charging, when the depth of the charging unit measured by the second measurement section and the previously stored depth of the charging unit are identical, as well as when the width of the feeding section measured by the first measurement section and the previously stored width of the feeding section are identical.

In such a configuration, the same advantage as that described above can also be achieved.

### BRIEF DESCRIPTION OF THE DRAWINGS

FIG. 1 is an appearance perspective view of a self-propelled cleaner according to the invention;

FIG. 2 is a reverse view of the self-propelled cleaner shown in FIG. 1;

FIG. 3 is a rear side view of the self-propelled cleaner shown in FIGS. 1 and 2;

FIG. 4 is a cross-sectional view taken along line A-A in FIG. 3;

FIG. 5 is a view showing the condition in which a charging unit according to the invention is mounted;

FIG. 6 is a block diagram showing the configuration of the self-propelled cleaner shown in FIGS. 1 and 2;

FIG. 7 is a flowchart showing the flow of the automatic cleaning execution process carried out in the self-propelled cleaner;

FIG. 8 is a view showing an example of the travel route in which the self-propelled cleaner travels when the automatic cleaning execution process shown in FIG. 7 is carried out;

FIG. 9 is a flowchart showing the flow of the automatic charging process that is called and carried out in Step S270 of the flowchart shown in FIG. 7;

FIG. 10 is a view showing the operation of the self-propelled cleaner when the automatic charging process shown in FIG. 9 is carried out;

FIG. 11 is a view showing the operation of the self-propelled cleaner when the automatic charging process shown in FIG. 9 is carried out;

FIG. 12 is a view showing the condition in which a feeding section of the charging unit is detected by a sidewall sensor;

FIG. 13 is a view showing the condition in which a body is rotated by 90 degrees from the position shown in FIG. 12;

FIG. 14 is a view showing the condition in which the charging unit according to the invention is mounted;

FIG. 15 is a flowchart showing the flow of the automatic charging process;

FIG. 16 is a view showing the operation of the self-propelled cleaner when the automatic charging process shown in FIG. 15 is carried out;

FIG. 17 is a view showing the condition in which the feeding section of the charging unit is detected by the sidewall sensor; and

FIG. 18 is a view showing the condition in which the body is rotated by 90 degrees from the position shown in FIG. 17.

### DESCRIPTION OF THE PREFERRED EMBODIMENTS

Hereinafter, the embodiments of the invention will be described in accordance with the following order.

First Embodiment

(1) Appearance of self-propelled cleaner:
(2) Inside configuration of self-propelled cleaner:
(3) Operation of self-propelled cleaner:
(4) Different variants: (5) Summary:

(1) Appearance of Self-propelled Cleaner:

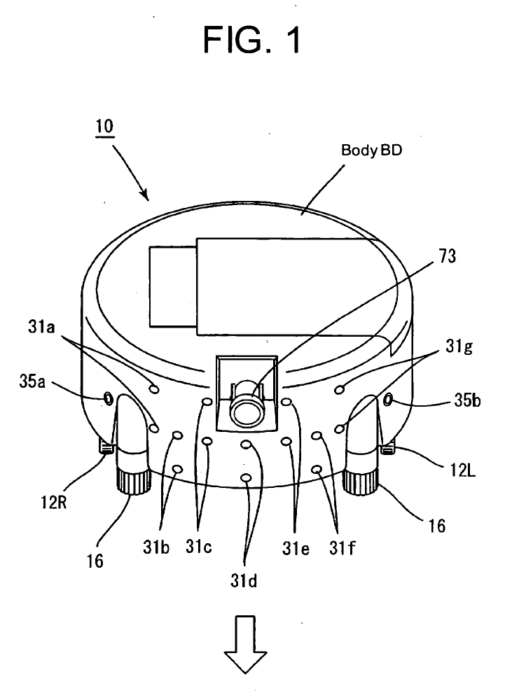

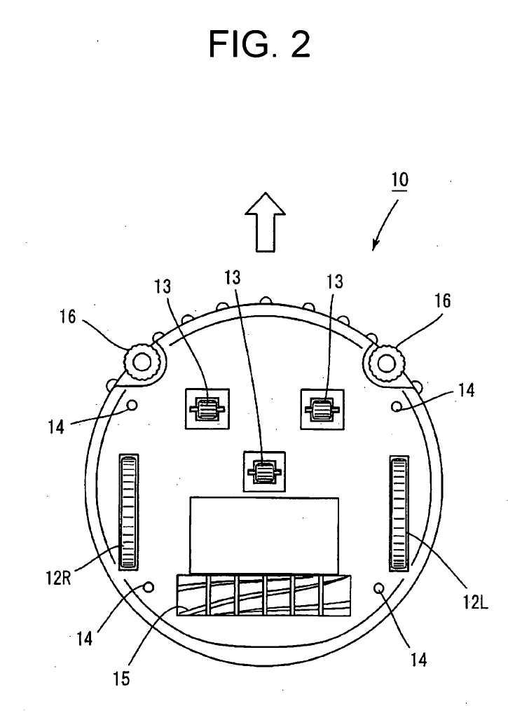

FIG. 1 is an appearance perspective view of a self-propelled cleaner according to the invention, and FIG. 2 is a reverse view of the self-propelled cleaner shown in FIG. 1. Incidentally, in FIG. 1, the direction indicated by arrow A is the traveling direction in which the self-propelled cleaner travels forward. As shown in FIG. 1, a self-propelled cleaner 10 according to the invention includes a body BD with a substantially cylindrical shape, and can travel straight, travel backward, and rotates around a predetermined pivot point by separately driving two drive wheels 12R, 12L (see FIG. 2) that are provided on the reverse side of the body BD. Further, an infrared CCD sensor 73 as the imaging sensor is provided in a central portion on the front side of the body BD.

Provided on the underside of the infrared CCD sensor 73 are seven ultrasonic sensors 31 (31a to 31g) as the front obstacle sensors. The ultrasonic sensors 31 each include an emission section for emitting ultrasonic waves and a receiving section for receiving ultrasonic waves reflected from the front wall, in which the distance to the wall can be calculated from a period of time when the ultrasonic waves emitted from the emission section are received by the reception section. Of the seven sensors 31, the ultrasonic sensor 31d is provided in the front center of the body BD, while the ultrasonic sensors 31a and 31g, the ultrasonic sensors 31b and 31f, and the ultrasonic sensors 31c and 31e are symmetrically provided respectively. When the traveling direction of the body BD is perpendicular to the front wall, the distances each measured by the ultrasonic sensors 31 symmetrically provided are identical to each other.

Further, pyroelectric sensors 35 (35a, 35b) are respectively provided in left and right on the front side of the body BD as the human sensors. The pyroelectric sensors 35a, 35b can detect a person who is present in the vicinity of the body BD by detecting the infrared light emitted from the human body. Incidentally, although not shown in FIG. 1, the pyroelectric sensors 35 (35c, 35d) are also respectively provided in left and right on the rear side of the body BD so that the detection range covers 360 degrees around the body BD.

Further, although not shown in FIG. 1, sidewall sensors 36 (36R, 36L) each made up of a photo reflector described below are provided in left and right on the rear side of the body BD. This photo reflector is for detecting a lateral wall to allow the self-propelled cleaner to keep a predetermined distance from the wall when traveling, and is also used for detecting the charging unit for the automatic charging described below. The position at which the sidewall sensor 36 is to be set will be described in detail below using the drawings.

In FIG. 2, the two drive wheels 12R, 12L are respectively provided in the left and right end portions in the reverse center of the body BD. Three auxiliary wheels 13 are respectively provided in the forward side (traveling direction side) on the reverse side of the body BD. Further, bump sensors 14 for detecting irregularities and bumps on the road are respectively provided in the upper right, lower right, upper left, and lower left portions on the reverse side of the body BD. In addition, a main brush 15 is placed below the reverse center of the body BD. This main brush 15 can be rotated and driven by a main brush motor 52 (not shown) to rack up the dust on the road. An opening at the portion in which the main brush 15 is attached is a suction port, so that the dust is racked up by the main brush 15 and sucked into the suction port. Further, side brushes 16 are respectively provided in the upper right and upper left portions on the reverse side of the body BD.

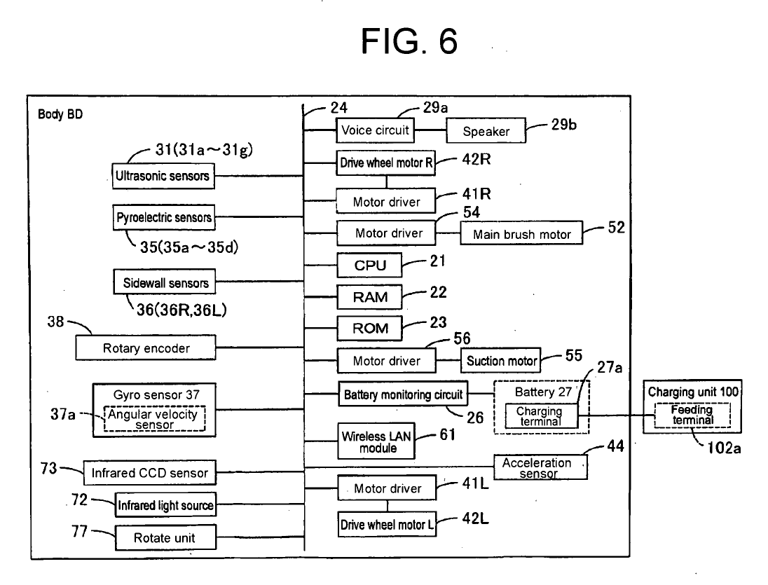

Incidentally, the self-propelled cleaner 10 according to the invention includes various sensors other than the ultrasonic sensors 31, pyroelectric sensors 35, bump sensors 14, and sidewall sensors 36 that are shown in FIGS. 1 and 2, and the various sensors will be described below using the drawing (FIG. 6).

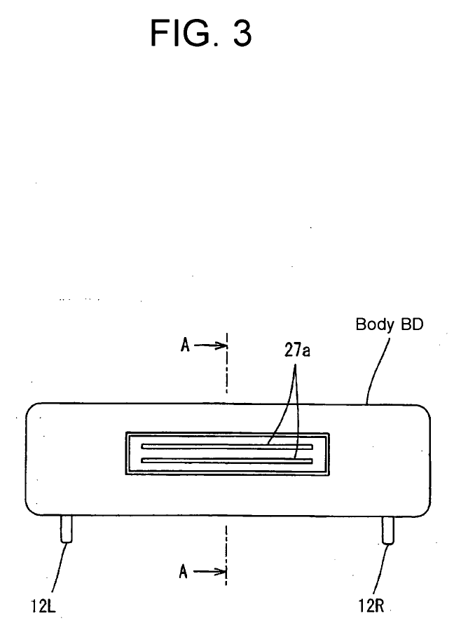

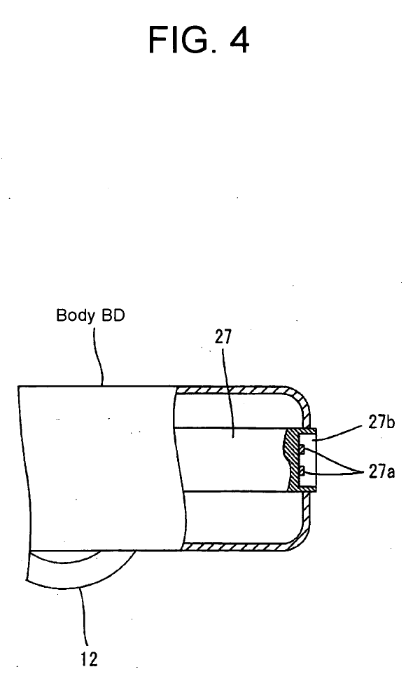

FIG. 3 is a rear side view of the self-propelled cleaner shown in FIGS. 1 and 2, and FIG. 4 is a cross-sectional view taken along line A-A in FIG. 3. As shown in FIGS. 3 and 4, on the periphery of the cylindrical body BD, a charging terminal 27a that is connected to a charging unit 100 described below to carry out charging is formed in a central portion on the rear side of the body BD. As shown in FIG. 4, a battery 27 is provided inside the body BD. At the rear end of the battery 27, there is formed a concave portion 27b with a rectangular shape when viewed from the cross-section, and the charging terminal 27a is provided in the concave portion 27b.

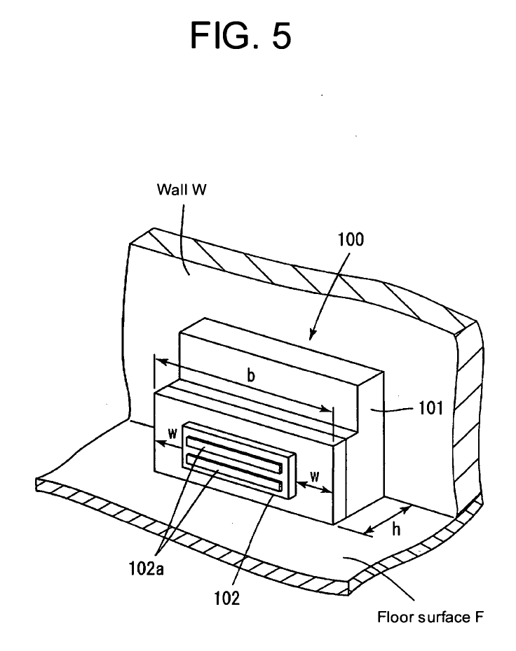

FIG. 5 is a perspective view showing the condition in which the charging unit according to the embodiment is mounted. In the figure, the charging unit 100 is mounted on wall W. This charging unit 100 includes a plug not shown, which is mounted by inserting the plug into an outlet not shown placed on the wall W and then is ready to charge. The charging unit 100 comprises a body section 101 mounted on the wall W so as to protrude therefrom with a step-like shape, and a feeding section 102 in which feeding terminal 102a to be connected to the charging terminal 27a in the self-propelled cleaner 10 is placed. The feeding section 102 has a convex shape protruding forward (in the opposite side to the wall W) relative to the body section 101. The charging unit 100 is mounted on the wall W in the state of protruding by predetermined width h forward from the wall W. The feeding section 102 is placed at distance w from an end of the body section 101. Incidentally, the two pieces of information about the width h and the distance w are stored in a ROM 23 (not shown) of the self-propelled cleaner 10. These pieces of information, which will be described below, are the information required for searching the charging unit 100 when the self-propelled cleaner carries out the automatic charging.

(2) Inside configuration of Self-propelled Cleaner

FIG. 6 is a block diagram showing the configuration of the self-propelled cleaner shown in FIGS. 1 and 2. In the figure, the body BD is connected with a CPU 21 as the control section, the ROM 23, and a RAM 22 via a bus 24. The CPU 21 provides different controls using the RAM 22 as the work area, in accordance with the control program and various parameters stored in the ROM 23.

The body BD has the battery 27, and the CPU 21 can monitor the remaining volume of the battery 27 via a battery monitoring circuit 26. The battery 27 includes the charging terminal 27a for charging from the above described charging unit 100. The charging terminal 27a is connected with the feeding terminal 102a of the charging unit 100 to carry out charging. The battery monitoring circuit 26 mainly monitors the voltage of the battery 27 and detects the remaining volume thereof. In addition, the body BD has a voice circuit 29a connected to the bus 24, and a speaker 29b makes voice in response to a voice signal generated in the voice circuit 29a.

Further, the body BD includes the ultrasonic sensors 31 (31a to 31g) as the front obstacle sensors, the pyroelectric sensors 35 (35a to 35d) as the human sensors, and the bump sensors 14 respectively (see FIGS. 1 and 2). The body BD also includes the sidewall sensors 36R, 36L for detecting the lateral wall as the other sensors that are not shown in FIGS. 1 and 2. The sidewall sensors 36R, 36L used herein are each made up of a photo reflector including an emission section for emitting infrared light and a receiving section for receiving infrared light reflected from the wall, but other sensors such as ultrasonic sensors can also be used for the sidewall sensors applied to the invention. In addition, the body BD includes a gyro sensor 37 as one of the other sensors described above. The gyro sensor 37 includes an angular velocity sensor 37a for detecting changes in the angular velocity caused by the change in the traveling direction of the body BD, and can detect the direction angle to which the body BD is directed by integrating the sensor output values detected by the angular velocity sensor 37a.

The self-propelled cleaner 10 according to the invention includes, as the drive mechanism, motor drivers 41R, 41L, drive wheel motors 42R, 42L, and a gear unit not shown that is placed between the drive wheel motors 42R, 42L and the above described drive wheels 12R, 12L. The drive wheel motors 42R, 42L are driven with the precise control of the rotate direction and rotate angle provided by the motor drivers 41R, 41L, when carrying out the rotate drive. Each of the motor drivers 41R, 41L outputs a corresponding drive signal in response to the control instruction from the CPU 21. Incidentally, the gear unit and the drive wheels 12R, 12L, for which various types are available, may be realized in such a manner that circular rubber tires or endless belts are driven.

The body BD also includes a rotary encoder 38. This rotary encoder 38 is integrally mounted to the drive wheel motors 42R, 42L, and can calculate the travel distance of the body BD from the rotation number of the drive wheels 12R, 12L. Incidentally, it is also allowable that instead the rotary encoder is directly connected to the drive wheels, freely rotatable driven wheels are placed in the vicinity of the drive wheels to allow the rotary encoder to detect the actual rotation volume by making provide feedback on the rotation number of the driven wheels, even if slip occurs in the drive wheels. An acceleration sensor 44 detects an accelerated velocity in the direction of the three axes XYZ and outputs the detection result.

The cleaning mechanism in the self-propelled cleaner 10 according to the invention comprises the two side brushes 16 (see FIG. 2) provided on the reverse side of the body BD, the main brush 15 (see FIG. 2) provided in the central portion on the reverse side of the body BD, and a suction fan (not shown) for sucking the dust racked up by the main brush 15 and storing it in a dust box. The main brush 15 is driven by a main brush motor 52, and the suction fan is driven by a suction motor 55. The main brush motor 52 and the suction motor 55 are supplied with drive electric power from motor drivers 54, 56 respectively. The cleaning using the main brush 15 is done in such a manner that the CPU 21 accordingly determines and controls the operation depending on the floor condition, the battery condition, the instruction of the user and other conditions.

The body BD has a wireless LAN module 61, so that the CPU 21 can wirelessly communicate with an external LAN in accordance with a predetermined protocol. The wireless LAN module 61 assumes that an access point not shown is present and that the access point is an environment capable of connecting to an external wide area network (e.g. the Internet) via a router and the like. Thus, it is possible to send and receive common e-mails and to browse WEB sites via the Internet. Incidentally, the wireless LAN module 61 comprises a standardized card slot and a standardized wireless LAN card connected to the slot and the like. It is needless to say that the card slot can be connected with another standardized card.

Further, the body BD includes an infrared CCD sensor 73 and an infrared light source 72. The imaging signal generated by the infrared CCD sensor 73 is sent out to the CPU 21 via the bus 24, and various processes are applied to the imaging signal in the CPU 21. The infrared CCD sensor 73 has an optical system capable of imaging the front, and generates an electrical signal in response to the infrared light input from the field of view that is realized by the optical system. More specifically, the infrared CCD sensor is provided with many photo diodes arranged corresponding to each of the pixels in the position of the image formed by the optical system, wherein each of the photo diodes generates an electrical signal corresponding to the electric energy of the input infrared light. The CCD element temporarily stores the electrical signals generated for each pixel, and generates an imaging signal in which the electrical signals for each pixel are continuous. Then, the infrared CCD sensor 73 outputs the generated imaging signal to the CPU 21 accordingly.

(3) Operation of Self-propelled Cleaner:

Next, the operation of the self-propelled cleaner 10 according to the invention will be described.

The self-propelled cleaner 10 according to the invention is configured to be able to do the cleaning while carrying out the automatic travel in accordance with the control program previously stored in the ROM 23 and the like. When a wall or irregularities on the floor is detected by the sensors during the cleaning in the automatic travel, the travel control is carried out based on the above described control program.

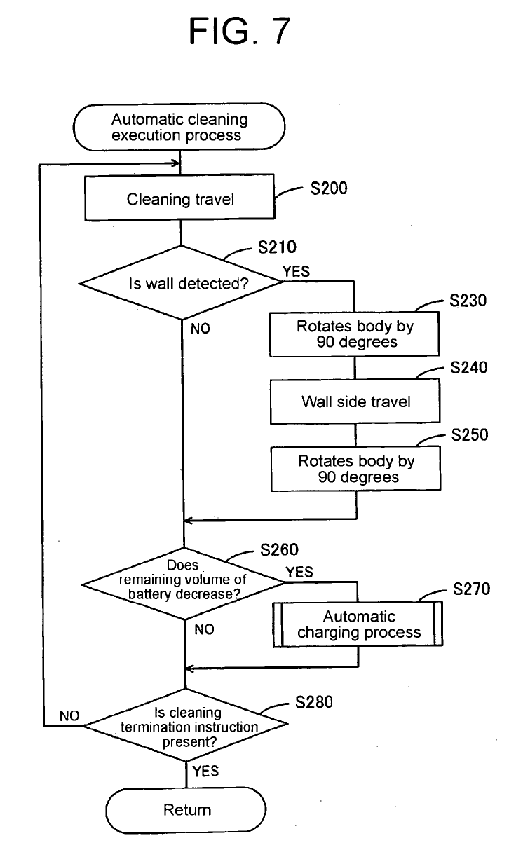

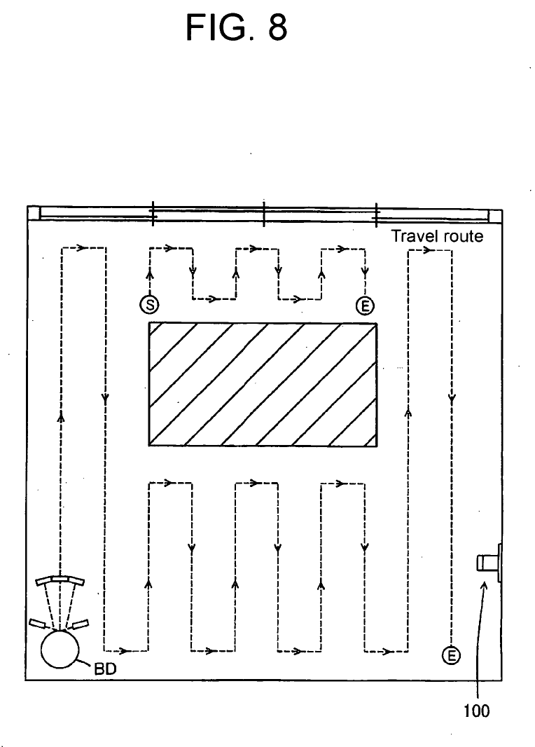

Hereinafter, the automatic cleaning execution process that is carried out by the self-propelled cleaner 10 according to the embodiment will be described based on the flowchart shown in FIG. 7. FIG. 7 is a flowchart showing the flow of the automatic cleaning execution process, and FIG. 8 is a view schematically showing an example of the travel route in which the self-propelled cleaner 10 travels when the automatic cleaning execution process is carried out. First, in Step S200, the self-propelled cleaner 10 carries out the cleaning travel. In this process of Step S200, the cleaner drives the drive wheel motors 42R, 42L to cause the body BD to travel straight, while inputting the detection results of the various sensors that the self-propelled cleaner 10 includes to carry out the drive control based on the detection results, further driving the main brush motor 52 and the suction motor 55 to allow them to carry out the cleaning operation. When detecting the change in the direction angle of the body BD by the gyro sensor 37, the cleaner corrects the traveling direction of the body BD by carrying out the drive control of the drive wheel motor 42R or 42L, thereby to keep the body BD traveling straight.

Having carried out the process in Step S200, next in Step S210, the cleaner determines whether or not to detect a front wall. In other words, it determines whether or not the wall located in the traveling direction of the body BD is detected by the ultrasonic sensors 31. When determining that the front wall is detected in Step S210, next in Step S230, the cleaner rotates the body by 90 degrees. With this process, the body BD travels parallel to the wall. For example, the cleaner starts the cleaning travel from the cleaning start position of the body BD shown in FIG. 8, and when detecting the upper wall in the figure, rotates the body BD by 90 degrees. Having carried out the process in Step S230, next in Step S240, the cleaner carries out the wall side travel. In this process, the cleaner carries out the cleaning travel, by driving the main brush motor 52 and the suction motor 55 to allow them to carry out the cleaning operation, while controlling the traveling direction to be parallel to the wall by the gyro sensor 37. After carrying out the wall side travel for a predetermined distance by Step S240, next in Step S250, the cleaner carries out again the process of rotating the body BD by 90 degrees. In FIG. 8, the body BD is rotated again to the right by 90 degrees after traveling for a predetermined distance along the upperwall, thereby the body BD is perpendicular to the wall and travels in the direction away from the wall.

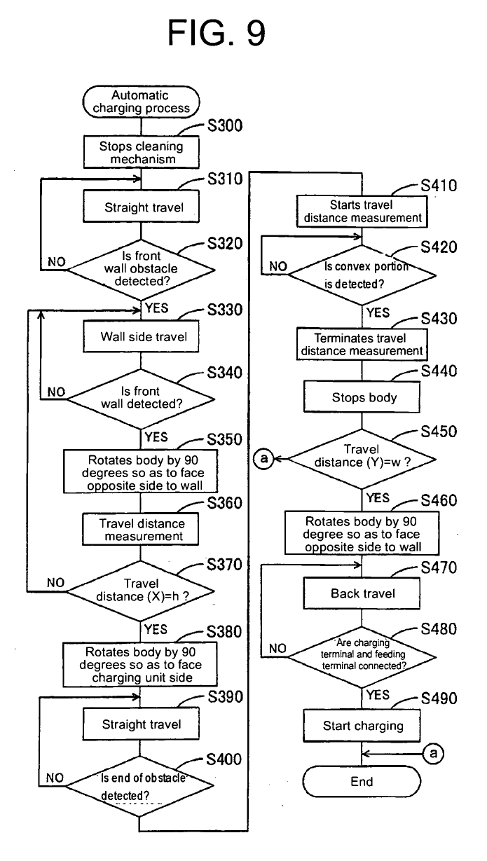

In the case of carrying out the process of Step S250 or determining not to have detected the wall in Step S210, next in Step S260, the self-propelled cleaner determines whether or not the remaining volume of the battery 27 decreases. In this process, the cleaner determines whether or not the remaining volume of the battery 27 detected by the battery monitoring circuit 27 falls below a predetermined reference value. When determining that the remaining volume of the battery 27 decreases in Step S260, the cleaner carries out the automatic charging process in Step S270. This process is that allows the body BD to automatically travel to the charging unit 100 mounted on a predetermined wall in the room to be cleaned, and connect the charging terminal 27a of the body BD to the feeding terminal 102a of the charging unit 100 to carry out charging. The automatic charging process will be described in detail below using the drawings (FIGS. 9 to 11).

In the case of carrying out the process of Step S270 or determining that the remaining volume of the battery 27 does not decrease in Step S260, next in Step S280, the cleaner determines whether or not an instruction to terminate the cleaning operation is present. When determining that the instruction is not present, the cleaner returns the process to Step S200, while when determining that the instruction is present, terminates the automatic cleaning execution process.

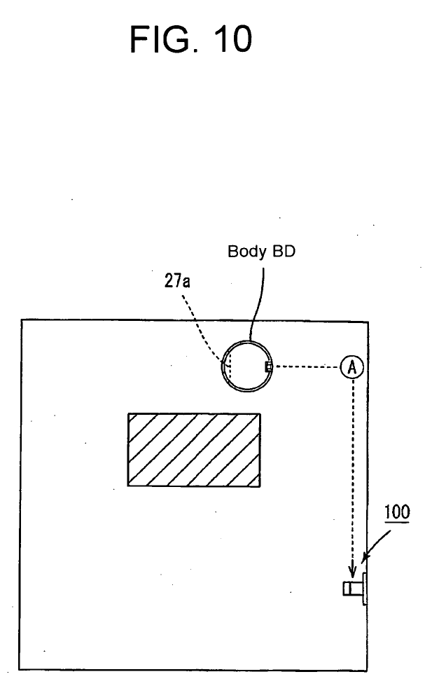

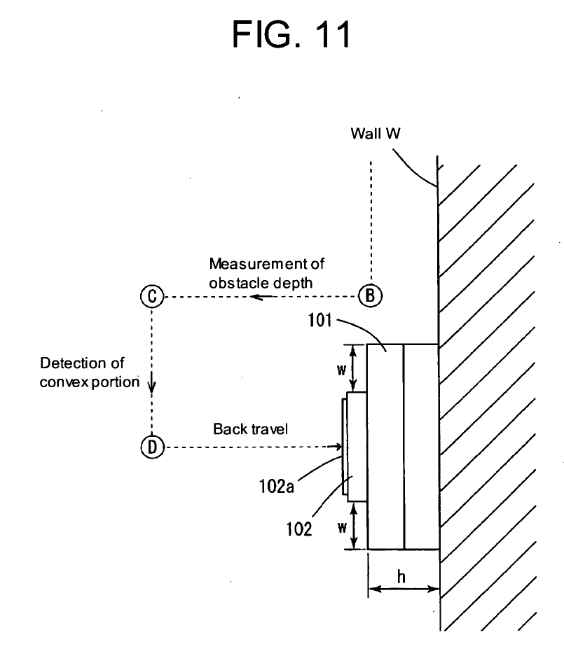

Next, the description will be made on the automatic charging process that is called and carried out in Step S270 of the flowchart shown in FIG. 7. FIG. 9 is a flowchart showing the flow of the automatic charging process that is called and carried out in Step S270 of the flowchart shown in FIG. 7. FIGS. 10 and 11 are views schematically showing the operation of the self-propelled cleaner 10 when the automatic charging process shown in FIG. 9 is carried out.

Upon the start of the automatic charging process shown in FIG. 9, first in Step S300, the self-propelled cleaner carries out the process of stopping the cleaning mechanism the self-propelled cleaner 10 includes. More specifically, the cleaner controls the motor driver 54 to stop the main brush motor 52 that drives the main brush 15, and also controls the motor driver 56 to stop the suction motor 55. Next, in Step S310, the cleaner carries out the straight travel. In other words, the cleaner drives the drive wheel motors 42R, 42L to allow the body BD to travel straight.

Having carried out the process of Step S310, next in Step S320, the cleaner determines whether or not the front wall is detected. In other words, it determines whether or not the front wall is detected by the ultrasonic sensors 31. When determining that the front wall is not detected by the ultrasonic sensors 31, the cleaner returns the process to Step S310 to keep the body BD traveling straight, while when determining that the front wall is detected, next in Step S330, causes the body BD to carry out the wall side travel. More specifically, the cleaner rotates the body BD by 90 degrees after approaching the front wall, and then further causes the body BD to travel straight to be parallel to the wall.

Having carried out the process of Step S330, next in Step S340, the cleaner determines whether or not a front obstacle is detected. In other words, it determines whether or not the front obstacle is detected by the ultrasonic sensors 31 during the wall side travel by the process of Step S330. In Step S340, when determining that the front obstacle is not detected, the cleaner returns the process to Step S330 to keep the body BD carrying out the wall side travel, while when determining that the front obstacle is detected, next in Step S350, rotates the body BD by 90 degrees so as to face the opposite side to the wall.

Having carried out the process of Step S350, next in Step S360, the cleaner carries out the process of measuring the travel distance of the body BD. In this process, the cleaner carries out the process of measuring the travel distance of the body BD by the rotary encoder 38, keeping the body BD traveling straight, while the lateral obstacle (the obstacle detected in Step S340) is being detected by the sidewall sensor 36. With this process of Step S360, it is possible to measure the depth of the obstacle.

Having carried out the process of Step S360, next in Step S370, the cleaner determines whether or not the travel distance (X) is identical to the width (h) of the charging unit 100 protruding from the wall surface. More specifically, the cleaner determines whether or not the travel distance (X) measured using the rotary encoder 38 by the above described process of Step S360 is identical to the width (h) of the charging unit protruding forward from the wall surface on which the charging unit is mounted. Incidentally, as described above, the width (h) of the charging unit protruding from the wall surface is previously stored in the ROM 23 of the self-propelled cleaner 10 and the like, and a comparison is made between this width (h) and the measured travel distance (X).

In Step S370, when determining that the travel distance (X) and the width (h) are not identical, the cleaner returns the process to Step S330, while when determining that the travel distance (X) and the width (h) are identical, next in Step S380, the cleaner rotates the body BD by 90 degrees so as to face the charging unit 100 side, and then carries out the process of causing the body BD to travel straight in Step S390. With the processes of Steps S380, S390, the body BD travels parallel to the wall so as to approach the charging unit 100.

Having carried out the process of Step S390, next in Step S400, the cleaner determines whether or not an end of the obstacle is detected. In other words, it determines whether or not the end of the obstacle is detected by the sidewall sensor 36 made up of a photo reflector. When determining that the end of the obstacle is not detected, the cleaner returns the process to Step S390 to keep the body BD traveling in the straight direction, while when determining that the end of the obstacle is detected, next in Step S410, starts the measurement of the travel distance. In other words, the cleaner starts the measurement of the travel distance of the body BD using the rotary encoder 38.

Having carried out the process of Step S410, next in Step S420, the cleaner determines whether or not a convex portion formed on the obstacle is detected in the measurement of the travel distance. In this process, the cleaner determines whether or not the convex portion formed on the obstacle (the feeding section 102 when this obstacle is the charging unit 100) is detected by the sidewall sensor 36. Incidentally, the following method may be included as the method that the sidewall sensor 36 detects the convexportion.

The convex portion is closer the sidewall sensor 36 than any other portion in the obstacle, so that the sensor output value of the sidewall sensor 36 is different between in the convex portion and in the other portion. Taking advantage of this fact, in the process of Step S420, the cleaner detects the presence of the convex portion by detecting the difference of the sensor output value of the sidewall sensor 36 when the infrared light is reflected in the convex portion.

When determining that the convex portion is not detected in Step S420, the cleaner returns the process to Step S420, while when determining that the convex portion is detected, in the following Step S430, the cleaner terminates the measurement of the travel distance of the body BD, and in the next Step S440, stops the travel of the body BD.

Having carried out the process of Step S440, next in Step S450, the cleaner determines whether or not the travel distance (Y) measured in the processes of Steps S410 to S430 described above is identical to the distance (w) (see FIG. 5) from the end of the body section 101 to the feeding section 102 in the charging unit 100. Incidentally, as described above, the distance (w) is previously stored in the ROM 23 of the self-propelled cleaner 10 and the like, and a comparison is made between this distance (w) and the measured travel distance (Y). In Step S450, when determining that the travel distance (Y) and the distance (w) are not identical, the cleaner terminates the automatic charging process as the obstacle is not the charging unit 100.

On the other hand, in Step S450, when determining that the travel distance (Y) and the distance (w) are identical, namely the obstacle is determined as the charging unit 100, in the process of Step S470 and successive processes, the cleaner carries out the processes involving the connection of the charging terminal 27a of the self-propelled cleaner 10 and the feeding terminal 102a of the charging unit 100. First, in Step S460, the cleaner carries out the process of rotating the body BD by 90 degrees so as to face the opposite side to the wall. With this process, the charging terminal 27a provided in the rear center of the body BD is opposed to the feeding terminal 102a of the charging unit 100.

Having carried out the process of Step S460, next in Step S470, the cleaner carries out the back travel of the body BD. With this process, as the body BD travels back, the charging terminal 27a provided in the body BD and the feeding terminal 102a of the charging unit 100 approach each other.

Having carried out the process of Step S470, next in Step S480, the cleaner determines whether or not the charging terminal 27a of the body BD and the feeding terminal 102a of the charging unit 100 are connected. When determining that they are not connected, the cleaner returns the process to Step S470 to continue the back travel of the body BD, while when determining that they are connected, in Step S490, starts charging in the state where the charging terminal 27a and the feeding terminal 102a are connected to each other. Then, having carried out the process of Step S490, the cleaner terminates the automatic charging process.

Hereinafter, the description will be made on a specific example of the case where the automatic charging process shown in FIG. 9 is carried out using FIGS. 10 and 11. First, when it is detected that the remaining volume of the batter 27 decreases, the self-propelled cleaner interrupts the automatic cleaning, and also stops the cleaning mechanism of the body BD (Step S300) to carry out the straight travel of the body BD (Step S310). Then, when the front wall is detected by the ultrasonic sensors 31, the cleaner approaches the wall, and rotates the body BD by 90 degrees at A point in FIG. 10 to carry out the wall side travel (Step S330).

The body BD carries out the wall side travel to approach the charging unit as shown in FIG. 10, and as it approaches, this charging unit 100 is detected by the ultrasonic sensors 31 as the obstacle (Step S340). Then, when the body BD approaches the vicinity (B point in FIG. 11) of the front obstacle (charging unit 100), the cleaner rotates the body BD by 90 degrees so as to face the opposite side to the wall surface W (Step S350), and keeps the body BD traveling away from the wall surface W, while measuring the depth of the above described obstacle (charging unit 100) (Step S360). This measurement result (travel distance X) is identical to the width (h) of the charging unit 100 protruding from the wall surface, thus the obstacle is determined as the charging unit 100 (Step S370: YES).

When the obstacle is determined as the charging unit 100, first, the cleaner causes the body BD to travel to C point in FIG. 11, rotates the body BD by 90 degrees so as to face the charging unit 100 side at the C point (Step S380), and then travels parallel to the wall W. Then, when the end of the obstacle (the end of the body section 101 of the charging unit 100) is detected by the sidewall sensor 36 during the travel (Step S400: YES), the cleaner starts the measurement of the travel distance (Step S410), and when the convex portion of the obstacle (the feeding section 102 of the charging unit 100) is further detected during the travel (Step S420: YES), the cleaner terminates the measurement of the travel distance (Step S430) and also stops the travel of the body BD (Step S440). Then, as the measurement result of the travel distance (travel distance Y) is identical to the distance w, this obstacle is determined as the charging unit 100.

Subsequently, the cleaner rotates the body BD by 90 degrees from the stop position of the body BD by Step S440 so as to face the opposite side to the wall surface W (Step S460). At this time, the charging terminal 27a formed on the body BD and the feeding terminal 102a of the charging unit 100 face each other. Then, the cleaner causes the body BD to travel back (Step S470) to connect the charging terminal 27a and the feeding terminal 102a, and thereby carries out charging.

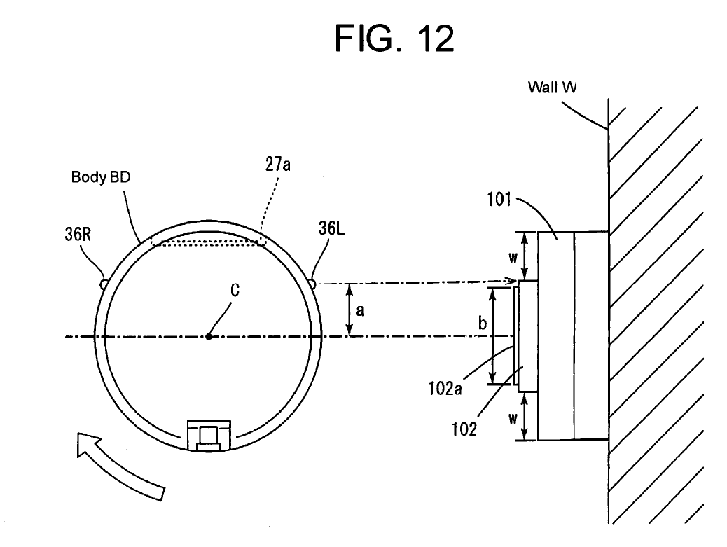

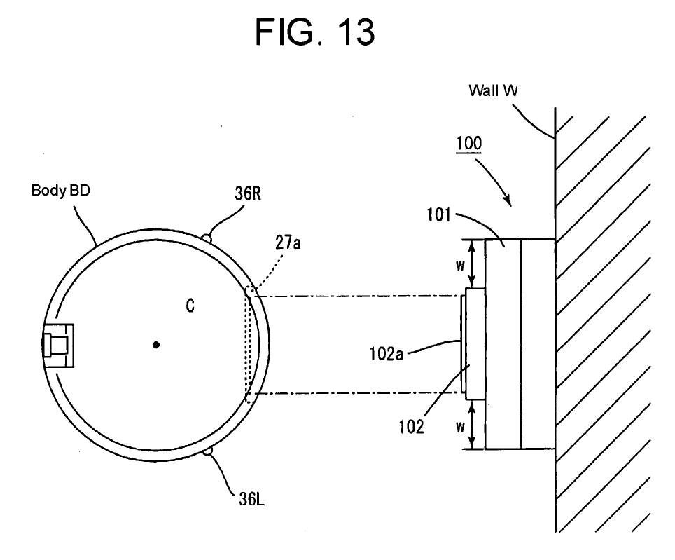

FIG. 12 is a view showing the condition in which the feeding section 102 of the charging unit 100 is detected by the sidewall sensors 36, and FIG. 13 is a view showing the condition in which the body BD is rotated by 90 degrees from the position shown in FIG. 12. In FIG. 12, as the sidewall sensor 36 (36 L) detects the feeding section 102 of the charging unit 100 when the body BD is traveling parallel to the wall W toward the charging unit 100, the self-propelled cleaner terminates the measurement of the travel distance and also stops the travel of the body BD. As a result of the measurement of the travel distance, when it is determined as the charging unit 100, the cleaner rotates the body BD by 90 degrees in the direction indicated by the outline arrow in the figure, and then travels back to connect with the charging unit 100. At the time of the rotation, the body BD rotates around the pivot point C.

In the self-propelled cleaner 10 according to the embodiment, the position of the sidewall sensor 36 is set to satisfy the following equation (1) for the distance (a) between the line (indicated by the dash-dotted line in the figure) extending perpendicular to the wall W from the pivot point C and the sidewall sensor 36L, and for the width (b) of the feeding section 102 of the charging unit 100.
a=(½)b (1)

With the position of the sidewall sensor 36 being set as described above, as shown in FIG. 12, the pivot point C is located just beside the central portion of the feeding section 102, when the sidewall sensor 36 detects the feeding section 102 and the body BD stops.

When the self-propelled cleaner rotates the body BD located in the position shown in FIG. 12 by 90degrees in the direction indicated by the outline arrow in the figure in order to carry out the connection with the charging unit 100, as shown in FIG. 13, the charging terminal 27a on the body BD side and the feeding terminal 102a of the charging unit 100 are located opposite each other without any displacement in the vertical direction, in which the cleaner causes the body BD to just travel back to connect the charging terminal 27a and the feeding terminal 102a to each other. In other words, there is no longer need to carry out the position adjustment of the body BD to allow the charging terminal 27a and the feeding terminal 102a to face each other without any displacement, after the feeding section 102 is detected by the sidewall sensor 36. This makes it possible to carry out the automatic charging smoothly.

(4) Different Variants:

In the above described embodiment, the description has been made on the case where the front obstacle sensor is the ultrasonic sensor, but the front obstacle sensor applied to the invention is not limited to the ultrasonic sensor, and may be any other sensor as long as can detect a front obstacle, such as the infrared sensor (photo reflector) including the emission section and receiving section of infrared light. Also, the description has been made on the case where the sidewall sensor is the photo reflector in the embodiment. However, the sidewall sensor is not specifically limited as well, and may be any other sensor as long as can detect an obstacle such as a lateral wall, such as the ultrasonic sensor.

Further, in the above described embodiment, the description has been made on the case where the traveling unit making up the rechargeable traveling system is the self-propelled cleaner including the cleaning mechanism, but the traveling unit applied to the invention is not limited to this, and may not have the cleaning mechanism. It is also allowable that the traveling unit does not include the imaging sensor (infrared CCD sensor 73) for detecting suspicious persons.

(5) Summary:

As described above, in the rechargeable traveling system according to the embodiment, because the position of the sidewall sensor 36 is set to satisfy the equation a=(½)b, when the body BD is parallel to the wall W, for the distance (a) between the line extending perpendicular to the wall W from the pivot point C and the sidewall sensor 36 and for the width (b) of the feeding section 102 of the charging unit 100, subsequently when the self-propelled cleaner rotates the body BD so that the charging terminal 27a provided in the central portion on the rear side of the body BD and the feeding terminal 102a of the charging unit 100 face each other, the charging terminal 27a and the feeding terminal 102a face each other without any displacement. Thus, the cleaner can connect the charging terminal 27a and the feeding terminal 102a by just traveling back after rotating the body BD, so that there is no need to carry out the position adjustment of the body BD and the automatic charging can be smoothly carried out.

Second Embodiment

(1) Variant appearance of charging unit:
(2) Operation of self-propelled cleaner:
(3) Summary:

(1) Variant Appearance of Charging Unit:

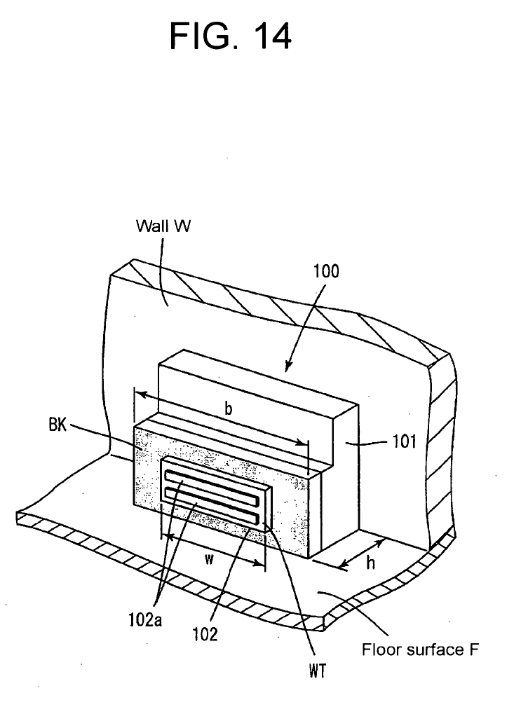

FIG. 14 is a perspective view showing a variant of the charging unit. The front portion of the body section 101 is a black colored part BK that is colored in black, and the front portion of the feeding section 102 is a white colored part WT that is colored in white. The white colored part WT has an infrared reflectance higher than that of the black formed part BK, so that the output value of the sidewall sensor 36 for the white colored part WT is higher than for the black colored part BK. Because the black colored part BK mostly absorbs the infrared light without reflecting it, the output value of the sidewall sensor 36 becomes substantially 0. In this embodiment, although described in detail below, the width of the feeding section 102 is measured by measuring the travel distance, during the wall side travel that the body BD is caused to travel parallel to the wall W, while the white colored part WT is being detected by the front sidewall sensor 36F (36FR or 36FL).

(2) Operation of Self-propelled Cleaner:

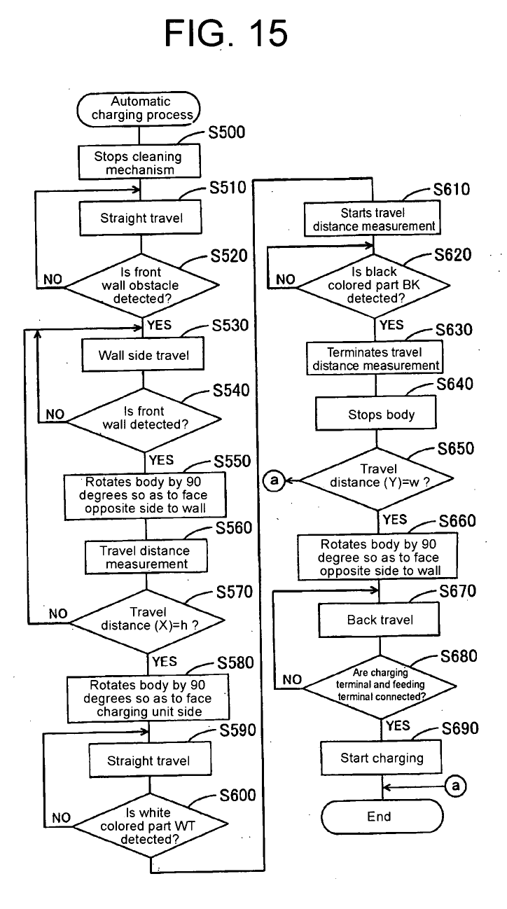

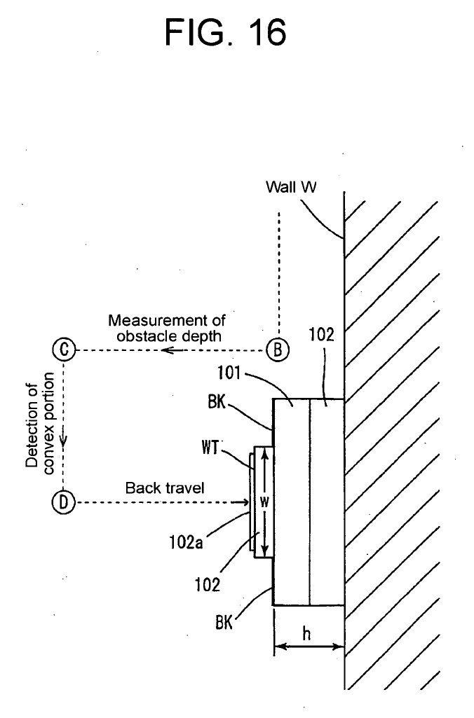

Next, FIG. 15 is a flowchart showing the flow of the automatic charging process that is called and carried out in Step S270 of the flowchart shown in FIG. 7. FIG. 16 is a view schematically showing the operation of the self-propelled cleaner 10 when the automatic charging process shown in FIG. 15 is carried out. Incidentally, the processes of Steps S500 to S590 are the same as those of Steps S300 to S390, and the description will be omitted.

Having carried out the process of Step S590, next in Step S600, the self-propelled cleaner determines whether or not the white colored part WT is detected. In this process, the cleaner determines whether or not the white colored part WT formed on the feeding section 102 is detected by the front sidewall sensor 36F (36FR or 36FL) during the travel parallel to the wall surface. With the above described process of Step S590, when the body BD is traveling parallel to the wall surface, the infrared light from the front sidewall sensor 36F is first irradiated onto the black colored part BK formed on the front of the body section 101 and then irradiated onto the white colored part WT, resulting that the sensor output value of the front sidewall sensor 36F increases because the infrared reflectance in the white colored part WT is good as described above. In the above described process of Step S600, the cleaner determines that the white colored part WT is detected as the sensor output value of the front sidewall sensor 36F increases.

When determining that the white colored part WT is not detected in Step S600, the cleaner returns the process to Step S590 to keep the body BD traveling straight, while when determining that the white colored part WT is detected, next in Step S610, starts the measurement of the travel distance. In other words, the cleaner starts the measurement of the travel distance of the body BD using the rotary encoder 38.

Having carried out the process of Step S610, next in Step S620, the cleaner determines whether or not the black colored part BK is detected. In this process, the cleaner determines whether or not the black colored part BK is detected by determining whether or not the sensor output value of the front sidewall sensor 36F decreases in association with the event where the irradiation of infrared light from the front sidewall sensor 36F is shifted from the white colored part WT to the black colored part BK. When determining that the black colored part BK is not detected in Step S620, the cleaner returns the process to Step S620, while when determining that the black colored part is detected, next in Step S630, terminates the measurement of the travel distance of the body BD, and stops the travel of the body BD in the following Step S640.

Having carried out the process of Step S640, next in Step S650, the cleaner determines whether or not the travel distance (Y) measured in the above described processes of Steps S610 to S630 is identical to the width (w) of the feeding section 102 in the charging unit 100 (see FIG. 5). Incidentally, as described above, the width (w) is previously stored in the ROM 23 of the self-propelled cleaner 10 and the like, and a comparison is made between this width (w) and the measured travel distance (Y) When determining that the travel distance (Y) and the width (w) of the feeding section 102 are not identical in Step S650, the cleaner terminates the automatic charging process as the obstacle is not the charging unit 100.

On the other hand, when determining that the travel distance (Y) and the width (w) of the feeding section 102 are identical in Step S650, namely the obstacle is determined as the charging unit 100, in the process of Step S760 and successive processes, the self-propelled cleaner carries out the processes involving the connection of the charging terminal 27a of the self-propelled cleaner 10 and the feeding terminal 102a of the charging unit 100. First, in Step S660, the cleaner carries out the process of rotating the body BD by 90 degrees so as to face the opposite side to the wall. With this process, the charging terminal 27a provided in the rear center of the BD and the feeding terminal 102a of the charging unit 100 face each other.

Having carried out the process of Step S660, next in Step S670, the cleaner carries out the back travel of the body BD. With this process, as the body BD travels back, the charging terminal 27a provided in the body BD and the feeding terminal 102a of the charging unit 100 approach each other.

Having carried out the process of Step S670, next in Step S680, the cleaner determines whether or not the charging terminal 27a of the body BD and the feeding terminal 102a of the charging unit 100 are connected. When determining that they are not connected, the cleaner returns the process to Step S670 to keep the body BD traveling back, while when determining that they are connected, in Step S690, starts charging in the state where the charging terminal 27a and the feeding terminal 102a are connected to each other. Then, having carried out the process of Step S690, the cleaner terminates the automatic charging process.

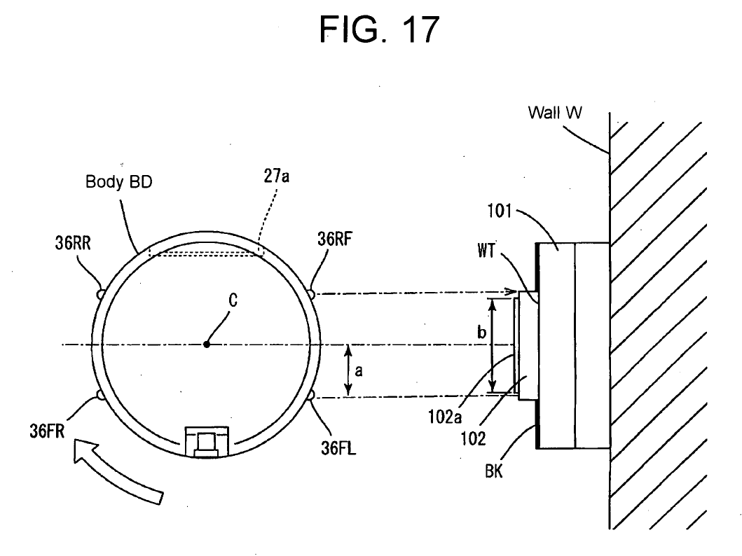

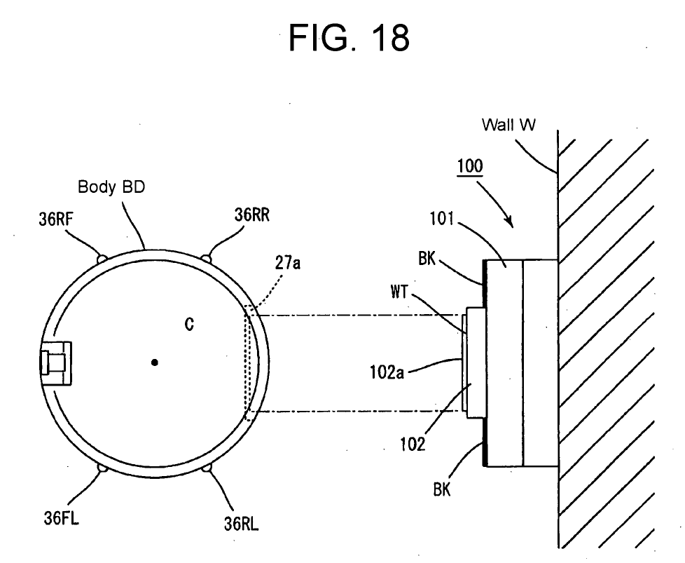

FIG. 17 is a view showing the condition in which the feeding section 102 of the charging unit 100 is detected by the sidewall sensor 36, and FIG. 18 is a view showing the condition in which the body BD is rotated by 90 degrees from the position shown in FIG. 17. In FIG. 17, the body BD is traveling parallel to the wall W toward the charging unit 100 with the front sidewall sensor 36FL detecting the white colored part WT formed on the feeding section 102 of the charging unit 100, and when the sidewall sensor 36FL detects the black colored part BK formed on the body section 101, the cleaner terminates the measurement of the travel distance and also stops the travel of the body BD. As a result of the measurement, when it is determined as the charging unit 100, the cleaner rotates the body BD by 90 degrees in the direction indicated by the outline arrow in the figure, and then travels back to connect with the charging unit 100. At the time of the rotation, the body BD rotates around the pivot point C.

In the self-propelled cleaner 10 according to the invention, the position of the sidewall sensor 36 is set to satisfy the following equation (1) for the distance (a) between the line (indicated by the dash-dotted line in the figure) extending perpendicular to the wall W from the pivot point C and the front sidewall sensor 36FL, and for the width (d) of the feeding section 102 of the charging unit 100.
a=(½)b (1)

With the position of the sidewall sensor 36 being set as described above, as shown in FIG. 17, when the sidewall sensor 36 detects the feeding section 102 and the body BD stops, the pivot position C is located at the central portion of the feeding section 102.

When the cleaner rotates the body BD in the position shown in FIG. 17 by 90 degrees in the direction indicated by the outline arrow in the figure, as shown in FIG. 18, the charging terminal 27a on the body BD side and the feeding terminal 102a of the charging unit 100 face each other, in which the cleaner causes the body BD just travel back to connect the charging terminal 27a and the feeding terminal 102a to each other. In other words, there is no longer need to carry out the position adjustment of the body BD to allow the charging terminal 27a and the feeding terminal 102a to face each other without any displacement, after the feeding section 102 is detected by the front sidewall sensor 36FL. This makes it possible to carry out the automatic charging smoothly.

(3) Summary:

As described above, in the rechargeable traveling system according to the embodiment, it is configured that the colors each having the different infrared reflectance are respectively formed on the body section 101 and feeding section 102 (black colored part BK, white colored part WT) of the charging unit 100, and the width of the feeding section 102 is measured by taking advantage of the fact that the sensor output value of the front sidewall sensor 36F (36FR or 36FL) varies in each of the parts, and when the measurement result is identical to the previously stored width (w) of the feeding section 102, it is determined as the charging unit 100 to carry out the charging. Thus, this eliminates the need to provide specific equipment on the charging unit 100 side, and makes it possible to find the charging unit and carry out the automatic charging without fail.

We claim:

1. A rechargeable traveling system comprising a self-propelled cleaner and a charging unit,
wherein the self-propelled cleaner includes: a drive mechanism for realizing steering and driving; a cleaning mechanism; front obstacle sensors for detecting a front obstacle, sidewall sensors for detecting a lateral obstacle; and a charging terminal for carrying out charging, placed in a central portion on the rear side of a cylindrical body, the self-propelled cleaner being capable of traveling straight, traveling backward and rotating around a predetermined pivot point, and
the charging unit has a convex shape with a predetermined width, which is mounted on a wall surface in a room so as to protrude therefrom and provided with a feeding section in which feeding terminal to be connected to the charging terminal of the self-propelled cleaner is placed,
the self-propelled cleaner further including an automatic charging control processor for allowing the self-propelled cleaner to connect the charging terminal to the feeding terminal of the charging unit, after carrying out the automatic travel and moving to the vicinity of the charging unit,
the automatic charging control processor including:
a first measurement section for measuring the depth of the obstacle by measuring the travel distance using a rotary encoder that measures the travel distance from the rotation number of the wheels, when the self-propelled cleaner carries out the wall side travel that travels along the wall in the room, and in response to the detection of a front obstacle by the front obstacle sensor during the wall side travel, rotates the body by 90 degrees and then travels perpendicular to the wall, while the obstacle is being detected by the sidewall sensor;
a second measurement section for measuring the distance from an end of the obstacle to a convex portion thereof by measuring the travel distance using the rotary encoder, when the self-propelled cleaner rotates the body by 90 degrees and then travels parallel to the wall after completion of the measurement by the first measurement section, during the period from when the end of obstacle is detected to when the convex portion formed on the obstacle is detected by the sidewall sensor; and
a charging unit search processor for determining whether or not the obstacle is the charging unit based on the measurement results by the first and second measurement sections,
wherein the cleaning mechanism is designed to be stopped during the automatic charging carried out by the automatic charging control processor, and
the position of the sidewall sensor is set to satisfy the equation (1), when the body is parallel to the wall, for the distance (a) between the line extending perpendicular to the wall from the pivot point of the body and the position in which the sidewall sensor is placed, and for the width (d) of the feeding section in the charging unit.
a=(½)b (1)

2. A rechargeable traveling system comprising a traveling unit and charging unit,
wherein the traveling unit includes: a drive mechanism for realizing steering and driving; front obstacle sensors for detecting a front obstacle; sidewall sensors for detecting a lateral obstacle; and a charging terminal for carrying out charging, placed in a central portion on the rear side of a body, the traveling unit being capable of traveling straight, traveling backward and rotating around a predetermined pivot point, and
the charging unit has a convex shape with a predetermined width, which is mounted on a wall surface in a room so as to protrude therefrom and provided with a feeding section in which feeding terminal to be connected to the charging terminal of the traveling unit is placed,
the traveling unit further including an automatic charging control processor for allowing the traveling unit to connect the charging terminal to the feeding terminal of the charging unit, after carrying out the automatic travel and moving to the vicinity of the charging unit,
the automatic charging control processor including:
a first measurement section for measuring the depth of the obstacle by measuring the travel distance using a rotary encoder that measures the travel distance from the rotation number of the wheels, when the traveling unit carries out the wall side travel that travels along the wall in the room, and in response to the detection of the front obstacle by the front obstacle sensors during the wall side travel, rotates the body by 90 degrees and then travels perpendicular to the wall, while the obstacle is being detected by the sidewall sensor;
a second measurement section for measuring the distance from an end of the obstacle to a convex portion thereof by measuring the travel distance, when the traveling unit rotates the body by 90 degrees and then travels parallel to the wall after completion of the measurement by the first measurement section, during the period from when the end of obstacle is detected to when the convex portion formed on the obstacle is detected by the sidewall sensor; and
a charging unit search processor for determining whether or not the obstacle is the charging unit based on the measurement results by the first and second measurement sections,
wherein the position of the sidewall sensor is set to satisfy the equation (1), when the body is parallel to the wall, for the distance (a) between the line extending perpendicular to the wall from the pivot point of the body and the position in which the sidewall sensor is placed, and for the width (d) of the feeding section in the charging unit.
a=(½)b (1)

3. The rechargeable traveling system according to claim 2, wherein the body of the traveling unit has a cylindrical shape.

4. The rechargeable traveling system according to claim 2, wherein the traveling unit includes a rotary encoder for measuring the travel distance from the rotation number of the wheels.

5. The rechargeable traveling system according to claim 2, wherein the traveling unit is a self-propelled cleaner including a cleaning mechanism.

6. The rechargeable traveling system according to claim 5, wherein the cleaning mechanism is stopped during the automatic charging carried out by the automatic charging control processor.

7. The rechargeable traveling system according to claim 2, wherein the sidewall sensors are placed in left and right on the rear side of the body, and each made up of a photo reflector including an emission section for emitting infrared light and a receiving section for receiving infrared light reflected from the wall, thereby detecting a lateral wall, keeping a predetermined distance from the wall in the travel, and also detecting the charging unit in order to carry out the automatic charging.

8. The rechargeable traveling system according to claim 2, wherein the body is provided therein with a battery having a concave portion formed at the rear end thereof, the concave portion having a rectangular shape when viewed from the cross-section and protruding in the rear center on the periphery of the body, and the charging terminal being provided in the concave portion.

9. The rechargeable traveling system according to claim 2, wherein the charging unit comprises a body section having a step-like shape mounted on the wall so as to protrude therefrom and a feeding section in which the feeding terminal to be connected to the charging terminal is placed, wherein the feeding section has a convex shape protruding toward the opposite side to the wall relative to the body section and is in the state of protruding by a predetermined width h forward from the wall when the charging unit is mounted on the wall, the feeding section also being placed at distance w from the end of the body section, the two pieces of information on the width h and the distance w being stored in a ROM within the traveling unit.

10. The rechargeable traveling system according to claim 2, wherein the drive mechanism includes: a pair of motor drivers; left and right drive wheel motors; left and right drive wheels; and a gear unit placed between the drive wheel motors and the drive wheels, wherein the drive wheel motors are precisely driven and controlled by the motor drivers in the rotation direction and the rotation angle in order to carry out the rotate drive, and each of the motor drivers outputs a corresponding drive signal in response to a predetermined control instruction from a CPU.

11. The rechargeable traveling system according to claim 2, wherein the body includes a rotary encoder integrally mounted to the drive wheel motors and can detect the rotation number of the drive wheels, thereby calculating the travel distance of the body from the rotation number thereof.

12. The rechargeable traveling system according to claim 11, wherein the rotary encoder detects the actual rotation volume even if slip occurs in the drive wheels, by placing freely rotatable driven wheels in the vicinity of the drive wheels and making provide feedback on the rotation amount of the driven wheels, instead of connecting the rotary encoder directly to the drive wheels.

13. The rechargeable traveling system according to claim 2, wherein the front obstacle sensor comprises an ultrasonic sensor that includes an emission section for emitting ultrasonic waves and a receiving section for receiving ultrasonic waves reflected from the front wall and that calculates the distance to the wall from a period of time when the ultrasonic waves emitted from the emission section are received by the receiving section.

14. The rechargeable traveling system according to claim 2, wherein the automatic charging control processor comprises:
determining whether or not the front wall is detected by the ultrasonic sensors, and when determining that the front wall is not detected, keeping the body traveling straight, while when determining that the front wall is detected, rotating the body by 90 degrees after approaching the front wall, and then causing the body to carry out the wall side travel that is the straight travel to be parallel to the wall;
next, determining whether or not the front obstacle is detected, and when determining that the front obstacle is not detected, keeping the body carrying out the wall side travel, while when determining that the front obstacle is detected, rotating the body by 90 degrees so that the body faces the opposite side to the wall;
next, measuring the depth of the front obstacle by measuring the travel distance (X) of the body using a rotary encoder, keeping the body traveling straight, while the lateral obstacle is being detected by the sidewall sensor;
next, determining whether or not the travel distance (X) is identical to the width (h) of the charging unit protruding from the wall surface, the width (h) being previously stored in a ROM of the traveling unit, and when determining that the travel distance (X) is identical to the width (h), rotating the body by 90 degrees so that the body faces the charging unit side to allow the body to travel straight, thereby parallel to the wall surface and approach the charging unit;
next, determining whether or not an end of the obstacle is detected by the sidewall sensor made up of a photo reflector, and when determining that the end of the obstacle is not detected, keeping the body traveling in the straight direction, while when determining that the end of the obstacle is detected, starting the measurement of the travel distance of the body using the rotary encoder;
next, detecting whether or not a convex portion formed on the obstacle is detected in the measurement of the travel distance, based on whether or not the sensor output value of the sidewall sensor varies, and when determining that the convex portion is detected, terminating the measurement of the travel distance (Y) of the body, as well as stopping the body from traveling;
next, determining whether or not the distance (Y) is identical to the distance (w) from the end of the body section to feeding section in the charging unit, the distance (w) being previously stored in the ROM of the traveling unit, and when determining that the distance (Y) is identical to the distance (w), rotating the body by 90 degrees so that the body faces the opposite side to the wall, thereby allowing the charging terminal placed in the rear center of the body to face the feeding terminal of the charging unit;
next, causing the body to travel back to allow the charging terminal provided in the body to be close to the feeding terminal of the charging unit;
next, determining whether or not the charging terminal of the body and the feeding terminal of the charging unit are connected, and when determining that they are not connected, keeping the body traveling back, while when determining that they are connected, starting charging in the state where the charging terminal and the feeding terminal are connected to each other, then terminating the automatic charging process.

15. A rechargeable traveling system comprising:
a traveling unit including: a drive mechanism for realizing steering and drive; front obstacle sensors for detecting a front obstacle; sidewall sensors each made up of a photo reflector for detecting a lateral obstacle; a travel distance measurement section for measuring the travel distance; and a charging terminal for carrying out charging, the traveling unit being capable of traveling straight, traveling backward, and rotating around a predetermined pivot point, and
a charging unit that is mounted on a wall surface in a room so as to protrude therefrom and provided with a feeding section in which a feeding terminal to be connected to the charging terminal of the traveling unit is placed, in a substantially central portion of the front of a body section,
wherein the body section and feeding section in the charging unit are configured to have the different reflectance of the infrared light emitted from the sidewall sensor respectively,
the traveling unit further including:
a first measurement section for measuring the width of the feeding section by measuring the travel distance by the travel distance measurement section, while the feeding section is being detected by the sidewall sensor, by taking advantage of the fact that the sensor output value is different between when the infrared light from the sidewall sensor is irradiated onto the body section and when it is irradiated onto the feeding section; and
a connection control processor for allowing the charging terminal of the traveling unit to be connected to the feeding terminal of the charging unit, by determining as the charging unit to carry out charging, when the width of the feeding section measured by the first measurement section is identical to the previously stored width of the feeding section.
